(19) United States
(12) Patent Application Publication
(10) Pub. No.: US 2020/0358314 A1
(43) Pub. Date: Nov. 12, 2020

(54) COMPUTING DEVICE FOR WIRELESSLY CHARGING PORTABLE COMPUTING DEVICE

(71) Applicant: Google LLC, Mountain View, CA (US)

(72) Inventors: Vijayasekaran Boovaragavan, Cupertino, CA (US); Veera Venkata Siva Nagesh Polu, Sunnyvale, CA (US); Srikanth Lakshmikanthan, Milpitas, CA (US); Douglas Osterhout, San Jose, CA (US); Liang Jia, Palo Alto, CA (US); Chao Fei, San Jose, CA (US); Zhenxue Xu, Cupertino, CA (US)

(21) Appl. No.: 16/405,396

(22) Filed: May 7, 2019

(51) Int. Cl. H02J 50/10; H02J 7/02; H02J 50/27

(52) U.S. Cl. CPC H02J 50/10; H02J 50/27; H02J 7/025

(57) ABSTRACT

A computing device can include a housing, a display secured by the housing, a charging coil included in a back side of the housing, the back side of the housing being on an opposite side from the display, and at least one magnet adjacent to the charging coil.

### TECHNICAL FIELD

This description relates to wirelessly charging computing devices.

### BACKGROUND

Wired charging interfaces can have varied physical form factors, making it difficult for computing devices to interoperate to provide electric charge to each other.

### SUMMARY

According to an example, a computing device can include a housing, a display secured by the housing, a charging coil included in a back side of the housing, the back side of the housing being on an opposite side from the display, and at least one magnet adjacent to the charging coil.

According to an example, a smartphone sleeve can include an insulator material biased to enclose a smartphone, and at least two metal portions surrounded by the insulator material, the at least two metal portions being between two millimeters and ten centimeters away from each other.

According to an example, a system for charging a smartphone from a computing device can include the computing device and the smartphone. The computing device can include a housing, a display secured by the housing, a charging coil included in a back side of the housing, the back side of the housing being on an opposite side from the display, and at least two magnets adjacent to the charging coil. The smartphone can be enclosed by a smartphone sleeve. The smartphone can include a receiving coil and a rechargeable battery coupled to the receiving coil. The smartphone sleeve can include an insulator material in a biased position, the biased position enclosing the smartphone, at least two metal portions surrounded by the insulator material, the at least two metal portions being at least two millimeters away from each other and less than ten centimeters away from each other. The at least two metal portions can be aligned with the at least two magnets. An attractive force between the at least two metal portions and the at least two magnets can be greater than a force of gravity on the smartphone.

The details of one or more implementations are set forth in the accompanying drawings and the description below. Other features will be apparent from the description and drawings, and from the claims.

### BRIEF DESCRIPTION OF THE DRAWINGS

FIG. 1A is a rear view of a computing device according to an example implementation.

FIG. 1B is a front view of the computing device of FIG. 1A according to an example implementation.

FIG. 1C is a perspective view of a computing device according to an example implementation.

FIG. 2A is a cross-sectional view of the computing device of FIG. 1A according to an example implementation.

FIG. 2B is a cross-sectional view of the computing device of FIG. 1A according to another example implementation.

FIG. 3 shows a smartphone inside a sleeve according to an example implementation.

FIG. 4A is a front view of the sleeve of FIG. 3 without the smartphone according to an example implementation.

FIG. 4B is a rear view of the sleeve of FIGS. 3 and 4A according to an example implementation.

FIG. 5 is a rear view of the smartphone of FIG. 3 according to an example implementation.

FIG. 6 is a timing diagram showing actions performed by either of the computing devices and the smartphone according to an example implementation.

FIG. 7 shows an example of a computer device and a mobile computer device that can be used to implement the techniques described here.

### DETAILED DESCRIPTION

A computing device, such as a tablet computing device or a laptop computing device, can wirelessly charge a portable computing device, such as a smartphone, an active or electronic stylus, or a watch. The computing device can wirelessly charge the portable computing device by producing a magnetic field. The portable computing device can induce a current from the magnetic field to recharge a battery of the portable computing device. The computing device can secure the portable computing device in a charging location, on the computing device, by magnets included on the computing device. The computing device can indicate the charging location, where a user should place the portable computing device on the computing device, by one or more light sources near, and/or around or proximate to, the charging location, such as light emitting diodes.

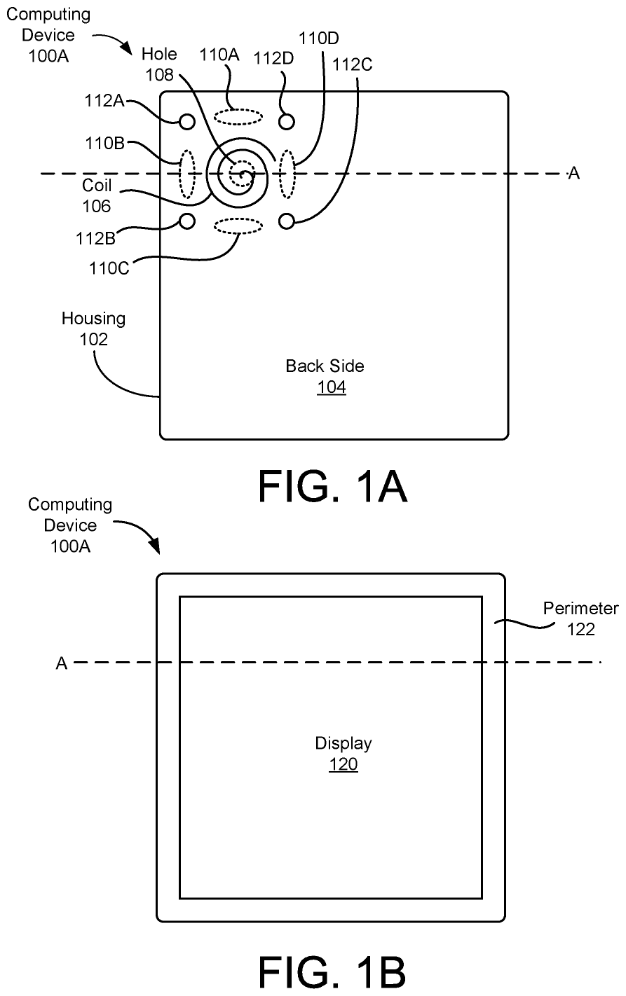

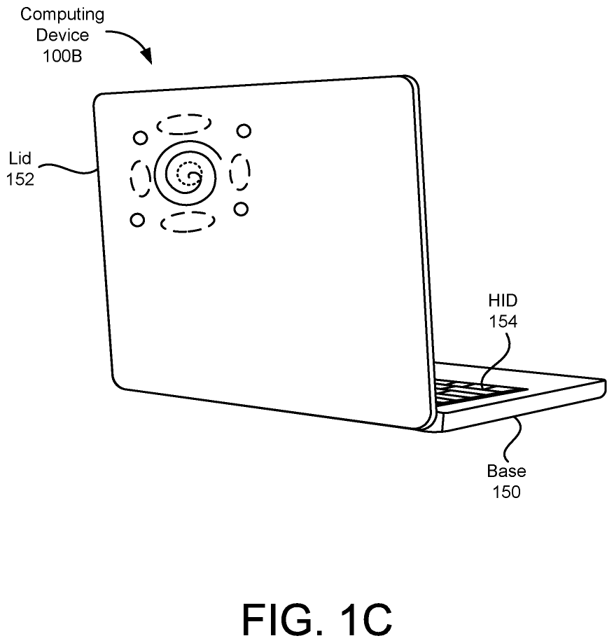

FIG. 1A is a rear view of a computing device 100A according to an example implementation. The computing device 100A can include, for example, a tablet computing device with a display 120 (shown in FIG. 1B) occupying (or defining) most or all of the front surface area.

The computing device 100A can include a housing 102. The housing 102 can support and/or secure other components of the computing device 100A. The housing 102 can include a rigid material, such as a metal, which can be partially covered or fully by an insulator material, such as a resin or a plastic.

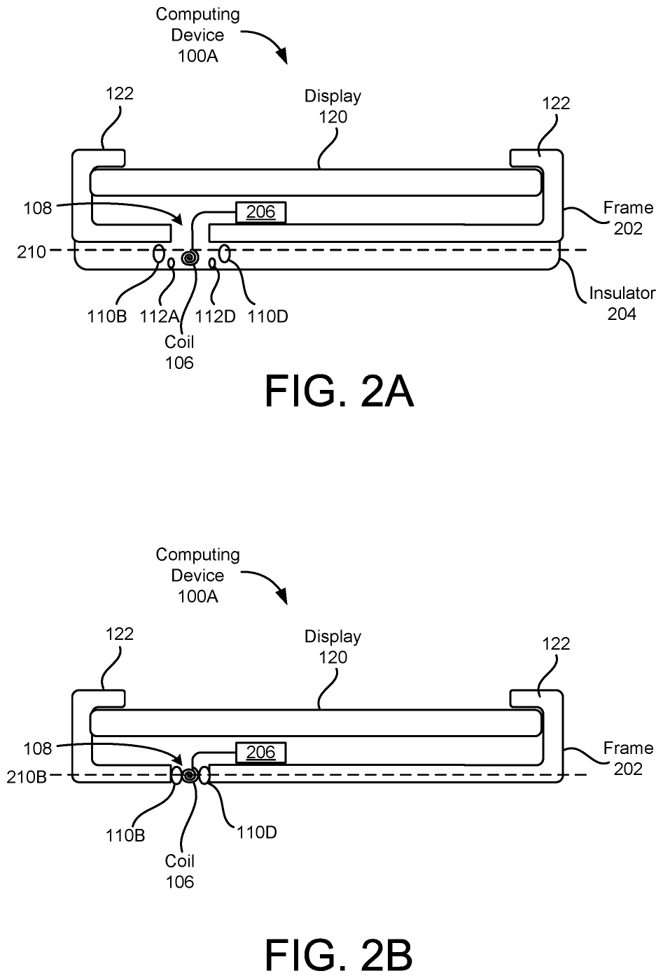

The computing device 100A can include a charging coil 106. The charging coil 106 can be made of a conductive material such as metal, including copper, aluminum, silver, or gold. The charging coil 106 can be included on (or within) a back side 104 of the housing 102. The back side 104 of the housing 102 can be on an opposite side of the housing 102 from the display 120. The back side 104 of the housing 102 can define a hole 108. The charging coil 106 can extend from a controller 206 (shown in FIG. 2A), which can be disposed between the back side 104 and the display 120. The charging coil 106 can extend from the controller 206 through the hole 108. The charging coil 106 can extend through the hole 108 into an insulator portion 204 (shown in FIG. 2A) of the back side 104 of the housing 102. The insulator portion 204 can cover the hole 108 and the coil 106. The insulator portion 204 can be opaque, so that the user cannot view either the hole 108 or the coil 106. The incorporation of the charging coil 106 and controller 206 into the computing device 100A should not interfere with other features that can be included in the computing device 100A, such as an antenna, NFC interface, Bluetooth interface, cellular interface, or other wired or wireless interfaces.

The charging coil 106 can be configured to produce a magnetic field. The charging coil 106 can produce the magnetic field when electric current flows through the charging coil 106.

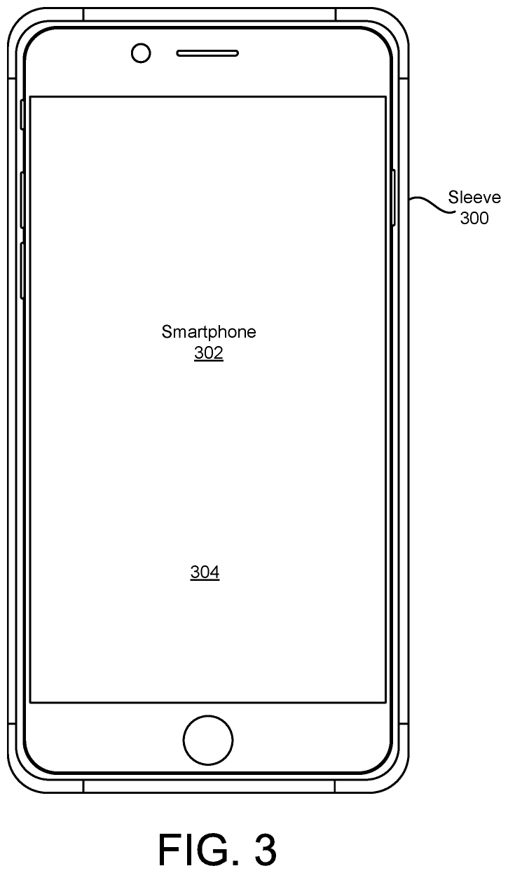

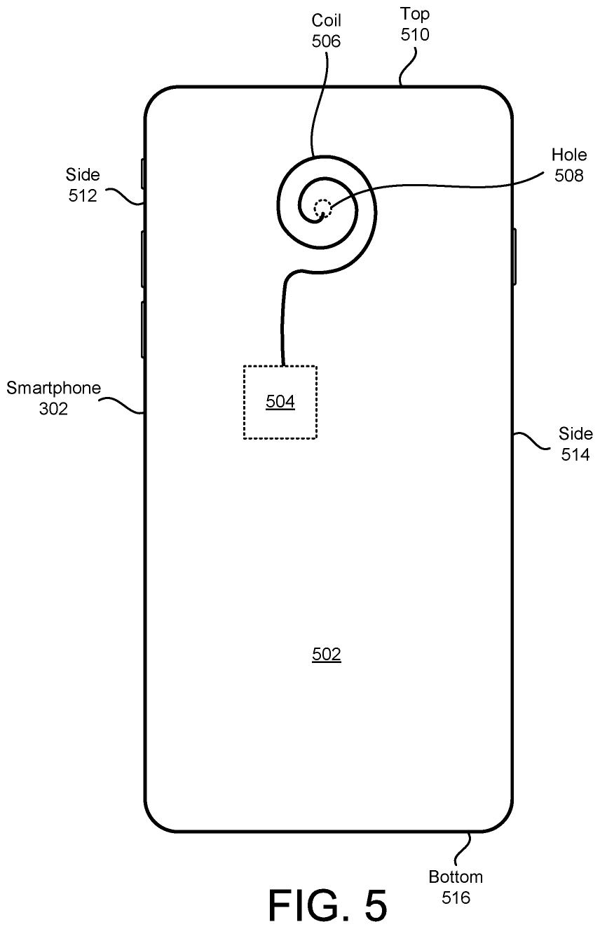

The magnetic field produced by the charging coil 106 can induce a current in a corresponding charging coil of a portable computing device, such as the smartphone 302 shown in FIGS. 3 and 5, proximate to the coil 106 (and outside of the back side 104 of the housing 102). A user can place the portable computing device in a charging area proximate to the charging coil 106. At least one light source, at least two light sources, and/or multiple light sources 112A, 112B, 112C, 112D (collectively light sources 112) around and/or proximate to the charging coil 106 can indicate to the user the charging area where the user should place the portable computing device so that the computing device 100A can charge the portable computing device. In some examples, the computing device 100A can also receive charge wirelessly from an external transmission coil and charge an internal rechargeable battery included in the computing device 100A. This feature is in addition to the computing device's 100A capability to charge the external devices, such as the portable computing device.

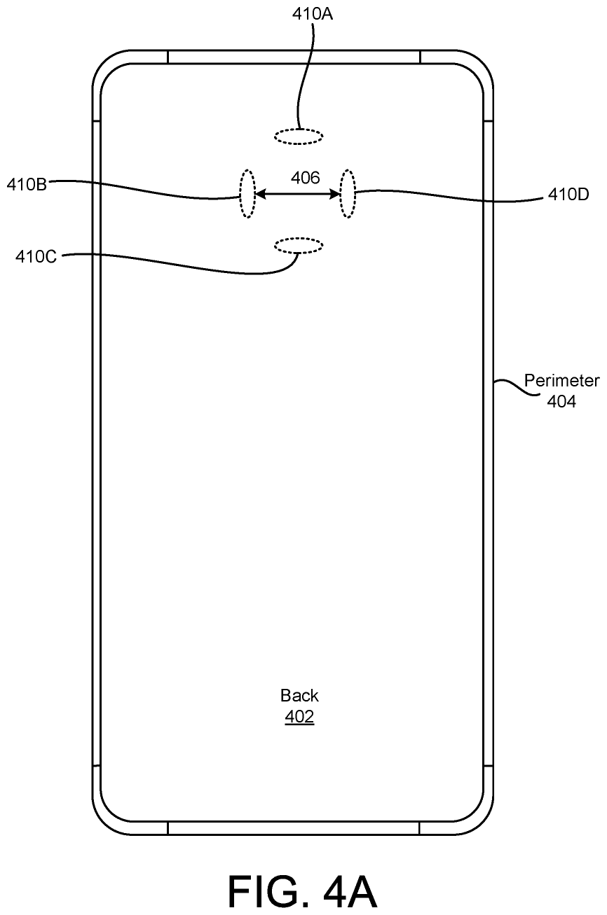

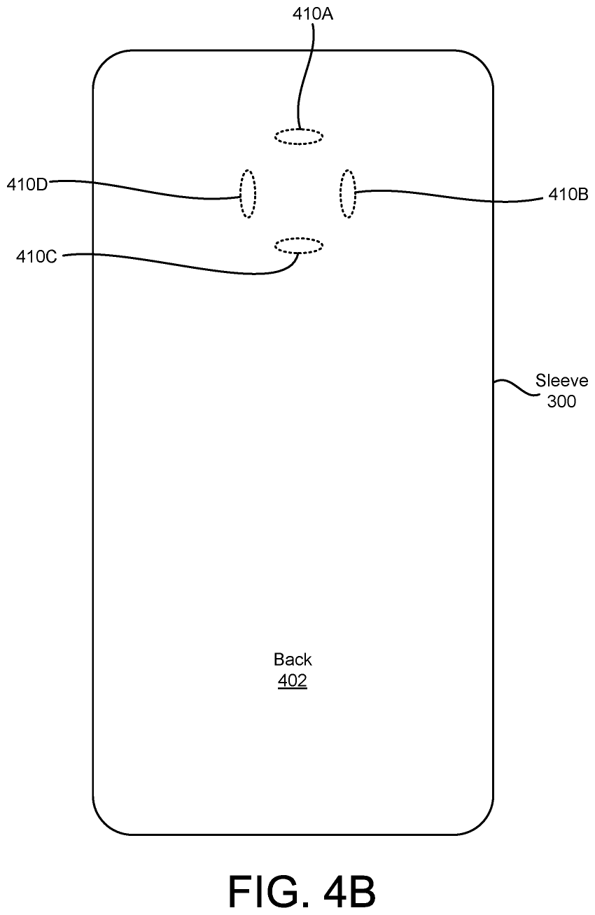

The computing device 100A can secure the portable computing device in the charging area proximate to the charging coil 106 by at least one magnet, at least two magnets, and/or multiple magnets 110A, 110B, 110C, 110D (collectively magnets 110). The magnets 110 can be adjacent to, such as proximate to, the coil 106. An arrangement of the magnets 110 can correspond to an arrangement of metal portions 410A, 410B, 410C, 410D (shown in FIG. 4A and collectively metal portions 410) included in a sleeve 300 (shown in FIGS. 3, 4A, and 4B) holding the portable computing device. The corresponding arrangement of the magnets 110 and metal portions 410 can cause the magnets 110 to attract the metal portions 410 with sufficient force to hold the portable computing device in the charging area of the computing device 100A. The magnets 110 can be strong enough that the force of attraction, and/or attractive force, between the magnets 110 and the metal portions 410 is stronger than a force of gravity on the portable computing device, securing the portable computing device to the charging area of the computing device 100. While the magnets 110 and metal portions 410 are shown as oval-shaped, they can be any shape, such as rectangular, square, or circular, as non-limiting examples. A magnet can also be included in the center and/or middle of the metal portions to hold accessories such as an earbud and/or watch.

The sleeve 300 shown in FIGS. 3, 4A, and 4B is an example of a device for holding an electronic device. In another example, the device for holding the electronic device could be a magnetic, flexible pouch that has a reception coil. The device for holding the electronic device can include a fastener attached to this pouch. The fastener can hold a smart-pen or electronic stylus. The device for holding the electronic device can enable the computing device 100A to charge the smart-pen or stylus wirelessly while the magnets 110 attract the device toward the coil 106.

FIG. 1B is a front view of the computing device 100A of FIG. 1A according to an example implementation. The display 120 is visible from the front view of the computing device 100A. The display 120 can present visual and/or graphic output to a user of the computing device 100. The display 120 can be surrounded by a perimeter 122 of the housing 102 (not labeled in FIG. 1B).

FIG. 1C is a perspective view of a computing device 100B according to an example implementation. In this example, the computing device 100B is a laptop or notebook computing device. The computing device 100B can include base 150 and a lid 152. The lid 152 can be rotatably attached to the base 150. The base 150 can include a processor (not shown in FIG. 1C) configured to send image instructions to a display, a memory (not shown in FIG. 1C), and one or more human interface devices (HIDs) 154, such as a keyboard and/or trackpad. Components of the lid 152 can be in communication with components of the base 150 via one or more wireless interfaces, and/or a wired interface via a hinge connecting the lid 152 to the base 150.

The lid 152 can include any combination of features described herein with respect to the computing device 100A. The lid 152 can include, for example, a housing display, a charging coil, magnets, and/or light sources. The base 150 can be hingedly coupled to the housing of the lid 152.

FIG. 2A is a cross-sectional view of the computing device 100A of FIG. 1A according to an example implementation. The cross-section can be taken along the line denoted ‘A’ in FIGS. 1A and 1B. As discussed above, the features and/or components of the computing device 100A can be included in the lid 152 of the computing device 100B.

The housing 102 (not labeled in FIG. 2A) can include a frame 202 and an insulator portion 204. The frame 202 can be made of a rigid material, such as metal, and/or can be considered a metal frame. The insulator 204 can overlay an outer portion of the frame 202 on the back side 104 of the housing 102. The insulator 204 can be made of an insulative material, such as plastic or resin.

The frame 202 can define the hole 108 through which the coil 106 extends. The coil 106 can extend through the hole 108 defined by the frame 202 into the insulator 204. A portion of the coil 106 can be disposed inside the insulator 204. The insulator 204 can be opaque, so that a viewer cannot see the coil 106 or the hole 108.

The magnets 110 can be disposed inside the insulator 204. The disposition of the magnets 110 inside the insulator 204 can prevent the magnets 110 from being viewed by the user. In some examples, the magnets 110 can be disposed inside and/or on the frame 202, and the insulator 204 can prevent the magnets from being viewed by the user. In some examples, the magnets 110 can be disposed on an opposite side of the frame 202 from the insulator 204.

The light sources 112 can be disposed partially inside the insulator 204. Portions of the light sources 112 can extend beyond the insulator 204. The extension of the portions of the light sources 112 beyond the insulator 204 can render light emitted by the light sources 112 visible to a user.

A charge controller 206 can be disposed on an opposite side of the frame 202 from the insulator 204 or in the base 150. The controller 206 can control the charging and/or communication activities of the coil 106. The controller 206 can, for example, ping and/or send probe messages to determine whether a portable computing device is proximate to the coil 106. In some examples, the controller 206 can communicate with a portable computing device that is proximate to the coil 106. In some examples, the controller 206 can communicate with the portable computing device to determine a charge level of the portable computing device. In some examples, the controller 206 can cause current to flow, and/or regulate current, through the coil 106, producing a magnetic field, based on the determined charge level of the portable computing device. In some examples, the controller 206 can prompt another wireless interface of the computing device 100A, such as an Institute for Electrical and Electronics Engineers (IEEE) 802.15 Bluetooth interface and/or a near-field communication (NFC) interface, to communicate with the portable computing device. The charge controller 206 can be on an opposite side of the frame 202 from the insulator 204, magnets 110, and/or light sources 112. In some examples, the multiple magnets 110 can all be intersected by a plane 210 that extends in a direction that is parallel to the display 120. The plane 210 can be on an opposite side of the frame 202 as the charge controller 206 and/or display 120. The light sources 112 can be on an opposite side of the frame 202 from the charge controller 206 and/or display 120.

FIG. 2B is a cross-sectional view of the computing device of FIG. 1A according to another example implementation. In this example, a cutout and/or hole 108 is formed in the frame 202 to accommodate the coil 106. An insulating material such as resin or plastic can cover and/or fill the cutout area and/or hole 108. In this example, the overall thickness of the back side 104 (not labeled in FIG. 2A) of the housing 102 will be the thickness of the frame 202, reducing the overall thickness of the computing device 100A compared to the example in FIG. 2A in which the insulator 204 is added to the frame 202. In some examples, the multiple magnets 110 can all be intersected by a plane 210B that extends through the frame 202 and cutout and/or hole 108 in a direction that is parallel to the display 120.

FIG. 3 shows a smartphone 302 inside a sleeve 300 according to an example implementation. The smartphone 302 can include a cellular telephone with a processor to perform computing functions and an interface, such as a touchscreen, for receiving input from, and providing output to, a user. In some examples, the smartphone 302 can be rectangular-prism shaped with six faces and/or sides, such as a front portion 304 visible in FIG. 3, a back portion 502 (shown in FIG. 5) opposite from the front portion 304, a top portion 510 (shown in FIG. 5), a bottom portion 516 (shown in FIG. 5), a right portion 512 (shown in FIG. 5), and a left portion 514 (shown in FIG. 5).

The sleeve 300 can at least partially enclose the smartphone 302 on five of six faces and/or sides of the smartphone 302. The sleeve 300 can be considered a smartphone sleeve. The sleeve 300 encloses the five sides other than the front face visible in FIG. 3. In some examples, the sleeve 300 can be in contact with a majority of the surface area of each of the five sides other than the front portion 304 visible in FIG. 3. The sleeve 300 can comprise an insulator material, such as rubber or plastic. The sleeve 300 can be biased to the position shown in FIG. 3, in which the sleeve 300 encloses the smartphone 302. A user can stretch the sleeve 300 out of the biased position shown in FIG. 3 to insert the smartphone 302 into the sleeve 300 and/or to remove the smartphone 302 from the sleeve 300.

FIG. 4A is a front view of the sleeve 300 of FIG. 3 without the smartphone 302 according to an example implementation. The sleeve 300 can include a back portion 402 surrounded by a perimeter portion 404. The back portion 402 can be in contact with the back portion 502 (shown in FIG. 5) of the smartphone 302 when the smartphone 302 is in the sleeve 300. The perimeter portion 404 can extend from the back portion 402 at a right angle. The perimeter portion 404 can be in contact with the top portion 510, side portions 512, 514, and the bottom portion 516 when the smartphone 302 is in the sleeve 300 (these portions 510, 512, 514, 516 of the smartphone 302 are labeled in FIG. 5).

The sleeve 300 can include metal portions 410A, 410B, 410C, 410D. The sleeve 300 can include multiple, and/or at least two, metal portions 410A, 410B, 410C, 410D. The metal portions 410A, 410B, 410C, 410D can include a ferromagnetic material attracted to magnets, such as iron. In some examples, the metal portions 410A, 410B, 410C, 410D can include magnets. The metal portions 410A, 410B, 410C, 410D can be disposed in the back portion 402 of the sleeve 300. In some examples, the metal portions 410A, 410B, 410C, 410D are entirely enclosed by the back portion 402 of the sleeve 300, which can render the metal portions 410A, 410B, 410C, 410D invisible to, and/or not viewable by, the user.

In some examples, the arrangement and/or distance between the metal portions 410A, 410B, 410C, 410D can correspond to the arrangement and/or distance between the magnets 110A, 110B, 110C, 110D included in the computing device 100A, 100B. The corresponding arrangement and/or distance between the metal portions 410A, 410B, 410C, 410D in the sleeve 300 and the arrangement and/or distance between the magnets 110A, 110B, 110C, 110D included in the computing device 100A, 100B can cause the metal portions 410A, 410B, 410C, 410D in the sleeve 300 to align with the magnets 110A, 110B, 110C, 110D included in the computing device 100A, 100B, attracting the metal portions 410A, 410B, 410C, 410D in the sleeve 300 to the magnets 110A, 110B, 110C, 110D included in the computing device 100A, 100B, securing the sleeve 300, and the smartphone 302 included in the sleeve 300, to the computing device 100A, 100B.

The metal portions 410A, 410B, 410C, 410D and corresponding magnets 110A, 110B, 110C, 110D can be spaced far enough apart to prevent interference with the magnetic field produced by the coil 106 (shown in FIGS. 1A and 2), but close enough to fit within the sleeve 300 that holds a smartphone 302. In some examples, a distance 406 between the metal portions 410A, 410B, 410C, 410D and corresponding magnets 110A, 110B, 110C, 110D can be at least two millimeters (2 mm), so that the metal portions 410A, 410B, 410C, 410D and corresponding magnets 110A, 110B, 110C, 110D are disposed at least one millimeter (1 mm) away from the charging coil 106. In some examples, the distance 406 between the metal portions 410A, 410B, 410C, 410D and corresponding magnets 110A, 110B, 110C, 110D can be less than ten centimeters (10 cm), so that the metal portions 410A, 410B, 410C, 410D and corresponding magnets 110A, 110B, 110C, 110D are disposed less than five centimeters (5 cm) away from the charging coil 106.

FIG. 4B is a rear view of the sleeve 300 of FIGS. 3 and 4A according to an example implementation. In the example shown in FIG. 4B, the four metal portions 410A, 410B, 410C, 410D are included in the back portion 402 of the sleeve 300. While four metal portions 410A, 410B, 410C, 410D are included in the example of FIG. 4A and 4B, the sleeve 300 can include any number of metal portions. The number of metal portions in the sleeve 300 can correspond to the number of magnets 110A, 110B, 110C, 110D in the computing device 100A, 100B.

FIG. 5 is a rear view of the smartphone 302 of FIG. 3 according to an example implementation. The smartphone 302 includes a top portion 510, side portions 512, 514, and a bottom portion 516 that, when the smartphone 302 is in the sleeve 300, are in contact with the perimeter portion 404 of the sleeve 300. The smartphone 302 includes a back portion 502 that is in contact with the back portion 402 of the sleeve 300 when the smartphone 302 is in the sleeve 300.

In an example in which the smartphone 302 includes a metallic enclosure, the back portion 502 of the smartphone 302 can define a hole 508. A coil 506 can extend from a rechargeable battery 504 through the hole 508. In an example in which the smartphone 302 includes a plastic or glass enclosure, the coil 506 can be included in and/or attached to an inner surface of the plastic or glass enclosure. The coil 506 can be made of a conductive material such as metal. The coil 506 can be considered a receiving coil. The coil 506 can be covered by a nonconductive material, such as glass, resin, or plastic. The coil 506 can induce a current from the magnetic field generated by the charging coil 106 (not shown in FIG. 5). The induced current can charge the rechargeable battery 504. The smartphone 302 can include the rechargeable battery 504, which can provide current and/or power to other components of the smartphone 302, such as a processor and display.

In some examples, the back portion 502 of the smartphone 302 can include metal. The metal can include a ferromagnetic material that is attracted to magnets, such as iron. In the examples in which the back portion 502 of the smartphone 302 includes metal, the smartphone 302 can be placed on the charging area of the computing device 100A and secured to the charging area of the computing device 100A without the smartphone 302 being placed into a sleeve 300.

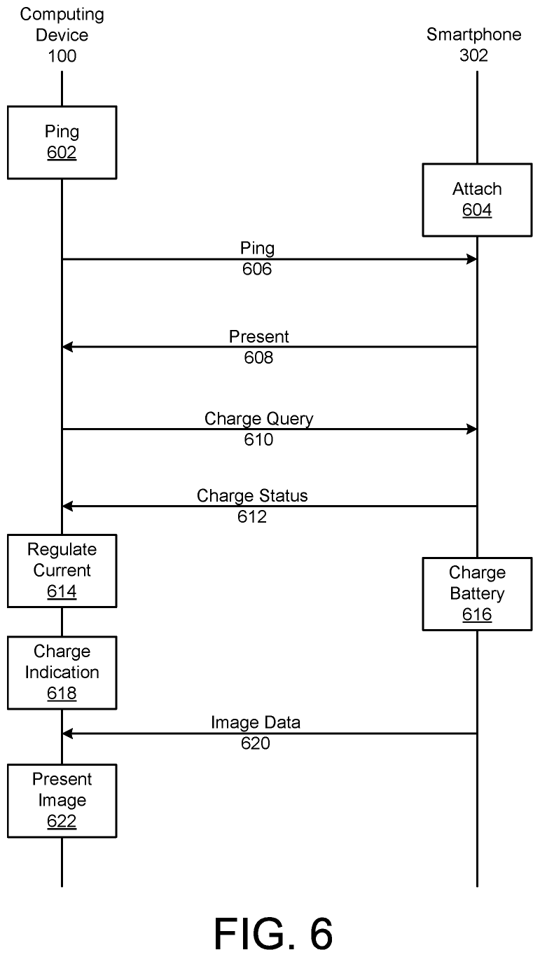

FIG. 6 is a timing diagram showing actions performed by either of the computing devices 100A, 100B (referred to generically as computing device 100) and the smartphone 302 according to an example implementation. The computing device 100 can periodically ping (602) and/or send probes. The computing device 100 can ping and/or send the probes via the charging coil 106. The ping signals and/or probes can have a frequency of less than one megahertz (1 MHz), such as approximately one hundred and forty-eight kilohertz (148 kHz), and can have signals encoded thereon using amplitude modulation (AM), frequency modulation (FM), or phase modulation (PM). The ping signals and/or probes can inquire whether a smartphone or other portable computing device, such as a stylus, is proximate to the charging coil 106. If the computing device 100 does not receive a response to the ping signals and/or probes, then the computing device 100 can continue pinging periodically (602).

A user can attach the smartphone 302 to the computing device 100 (604). The user can attach the smartphone 302 to the computing device 100 (604) by aligning the metal portions 410A, 410B, 410C, 410D of the sleeve 300, in which the smartphone 302 has been inserted, with the magnets 110A, 110B, 110C, 110D of the computing device 100. The user can be guided to align the metal portions 410A, 410B, 410C, 410D of the sleeve 300 with the magnets 110A, 110B, 110C, 110D of the computing device 100 by the light sources 112A, 112B, 112C, 112D of the computing device 100.

After the smartphone 302 is attached to the computing device 100 (604), the computing device 100 can send a ping signal 606 and/or probe that is received and processed by the smartphone 302. The smartphone 302 can respond to the ping 606 by sending a device present signal 608 to the computing device 100. The device present signal 608 can indicate presence and/or proximity of the smartphone 302 in the charging area and/or coil 106. The smartphone 302 can send the device present signal 608 to the computing device 100 via the coil 506 included in the smartphone 302, or via another wireless interface, such as a Bluetooth or NFC interface. In some examples, the computing device 100 can indicate the presence, attachment, and/or connection of the smartphone 302 to the computing device 100. The computing device 100 can indicate the presence, attachment, and/or connection of the smartphone 302 to the computing device 100 via the light sources 112A, 112B, 112C, 112D, such as by causing the light sources 112A, 112B, 112C, 112D to blink upon the presence, attachment, and/or connection of the smartphone 302 to the computing device 100.

In some examples, after the computing device 100 has determined that the smartphone 302 is present, the computing device 100 can output an alert in response to a person other than the user and/or owner of the smartphone 302 removing the smartphone 302 from the computing device 100. The computing device 100 can output the alert by, for example, flashing lights via the light sources 112A, 112B, 112C, 112D and/or display 120, and/or by emitting an audible sound via speakers included in the computing device 100. The computing device 100 can determine that the smartphone 302 has been removed from the computing device 100 based on not receiving a present signal in response to a subsequent probe signal. The computing device 100 can determine that the smartphone 302 has been removed from the computing device 100 by someone other than the user and/or owner of the smartphone based on receiving a signal from the smartphone 302, and/or based on not receiving a signal from the smartphone 302, such as a signal sent from the smartphone 302 in response to a user unlocking the smartphone using either a passcode and/or biometric identification.

In some examples, the computing device 100 can send a charge query 610 to the smartphone 302 in response to receiving the present signal 608. The smartphone 302 can respond to the charge query 610 by sending a charge status signal 612 to the computing device 100. The charge status signal 612 can indicate a charge status of the rechargeable battery 504 included in the smartphone 302.

The pings 602, 606 and/or charge query 610 can generate a small magnetic field. The small magnetic field can induce a small current in the charging coil 506 of the smartphone 302.

Based on the charge status signal 612 and/or the device present signal 608, the computing device 100 can regulate the current in the transmitter coil 106 included in the computing device 100 (614). The computing device 100 can regulate the current (614) by increasing the current flowing through the transmitter coil 106. Increasing the current flowing through the transmitter coil 106 can increase the strength of the magnetic field generated by the current, transmitter coil 106, and/or computing device 100. The computing device 100 can increase the current and/or magnetic field by, for example, a factor of ten or twenty compared to the current and/or magnetic field generated by the pinging 602, 606 and/or charge query 610. The larger and/or stronger magnetic field generated by the higher current flowing through the transmitter coil 106 will induce a higher current in smartphone coil 506. Based on the higher current flowing through the coil 506, the smartphone 302 can charge (616) and/or recharge the rechargeable battery 504 included in the smartphone 302.

In some examples, the computing device 100 can present a charge indication (618). The charge indication can indicate the charge level of the rechargeable battery 504 included in the smartphone 302. The charge indication can be based on the charge status signal 612 that the computing device 100 received from the smartphone 302. The charge indication can be presented via the light sources 112A, 112B, 112C, 112D (collectively light sources 112) included in the computing device 100. In some examples, the light sources 112 emitting red can indicate a low charge level of the rechargeable battery 504, the light sources 112 emitting yellow can indicate a medium charge level of the rechargeable battery 504, and/or the light sources 112 emitting green can indicate that the rechargeable battery 504 is fully or almost fully charged.

In some examples, the smartphone 302 can send image data 620 to the computing device 100. The image data 620 can include a presentation on a display of the smartphone 302. The smartphone 302 can project the screen of the smartphone onto the computing device 100 by sending the image data 620 via a wireless interface other than the coil 506, such as via a Bluetooth or NFC interface. The computing device 100 can respond to receiving the image data 620 by presenting an image (622) on the display 120 of the computing device 100 based on the image data 620. In some examples, while the image data 620 has been sent to computing device 100, there is no more duplication of that image data 620 on the smartphone 302. This can avoid the image being seen by other people while the computing device 100 display 120 is placed vertically.

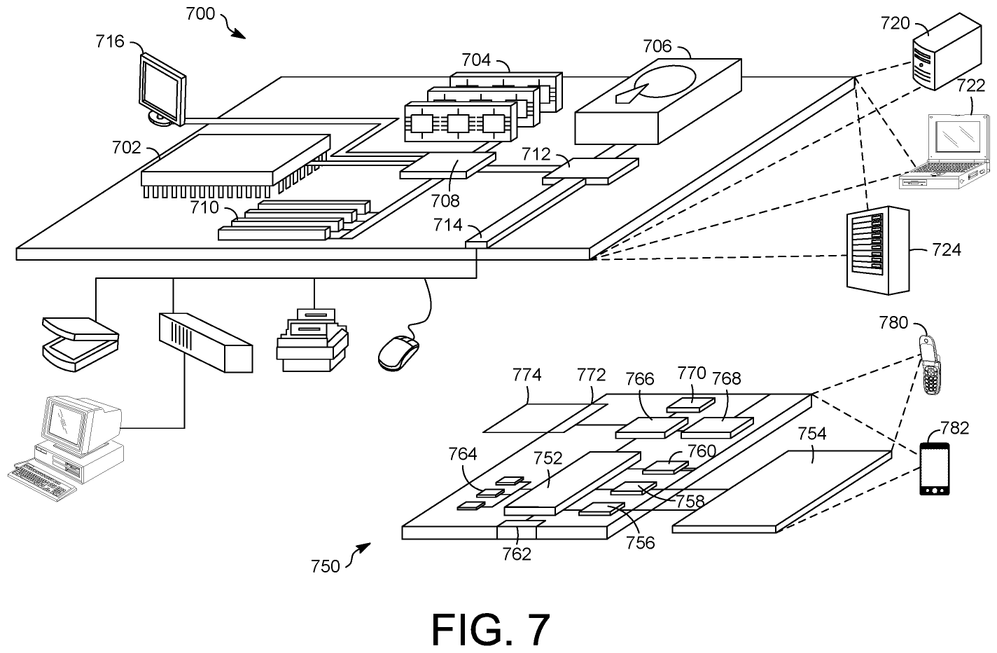

FIG. 7 shows an example of a generic computer device 700 and a generic mobile computer device 750, which may be used with the techniques described here. Computing device 700 is intended to represent various forms of digital computers, such as laptops, desktops, tablets, workstations, personal digital assistants, televisions, servers, blade servers, mainframes, and other appropriate computing devices, and can be an example of either computing device 100A, 100B. Computing device 750 is intended to represent various forms of mobile devices, such as personal digital assistants, cellular telephones, smartphones, and other similar computing devices, and can be an example of the portable computing device and/or smartphone 302. The components shown here, their connections and relationships, and their functions, are meant to be exemplary only, and are not meant to limit implementations of the inventions described and/or claimed in this document. The computing device 100 (100A) could also receive charge wirelessly from the external Tx coil and charge the internal battery in the computing device 100 (100A).

Computing device 700 includes a processor 702, memory 704, a storage device 706, a high-speed interface 708 connecting to memory 704 and high-speed expansion ports 710, and a low speed interface 712 connecting to low speed bus 714 and storage device 706. The processor 702 can be a semiconductor-based processor. The memory 704 can be a semiconductor-based memory. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provided as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the following some examples are described.

Example 1: A computing device comprising:
a housing;
a display secured by the housing;
a charging coil included in a back side of the housing, the back side of the housing being on an opposite side from the display; and
at least one magnet adjacent to the charging coil.

Example 2: The computing device of example 1, wherein the back side of
the housing includes:
a metal frame; and
an insulator portion on an opposite side of the metal frame from the display,
wherein the charging coil is disposed within the insulator portion.

Example 3: The computing device of example 2, wherein:
the metal frame defines a hole; and
the charging coil extends through the hole.

Example 4: The computing device of any of examples 1-3, wherein the at least one magnet is disposed at least one millimeter away from the charging coil and less than five centimeters away from the charging coil.

Example 5: The computing device of any of examples 1-4, wherein the at least one magnet comprises at least two magnets on opposite sides of the coil.

Example 6: The computing device of any of examples 1-5, further comprising at least two light sources on opposite sides of the charging coil.

Example 7: The computing device of any of examples 1-6, wherein the computing device is configured to generate a magnetic field via the charging coil in response to determining that a portable computing device is proximate to the charging coil.

Example 8: The computing device of any of examples 1-7, wherein the computing device is configured to periodically send a ping signal via the charging coil.

Example 9: The computing device of example 8, wherein the ping signal has a frequency of less than one megahertz (1 MHz).

Example 10: The computing device either of examples 8 or 9, wherein the computing device further comprises a charge controller, the charge controller being configured to determine that a portable computing device is proximate to the charging coil based on receiving a device present signal in response to the probe signal.

Example 11: The computing device of example 10, wherein the charge controller is supported by the housing.

Example 12: The computing device of either of examples 10 or 11, wherein the computing device is configured to generate a magnetic field via the charging coil in response to the charge controller determining that the portable computing device is proximate to the charging coil.

Example 13: The computing device of any of examples 1-12, further comprising a base hingedly coupled to the housing, the base comprising a processor configured to send image instructions to the display.

Example 14: A smartphone sleeve comprising:
an insulator material biased to enclose a smartphone; and
at least two metal portions surrounded by the insulator material, the at least two metal portions being between two millimeters and ten centimeters away from each other.

Example 15: The smartphone of example 14, wherein the insulator material comprises rubber.

Example 16: The smartphone of example 14, wherein the insulator material comprises plastic.

Example 17: The smartphone of any of examples 14-16, wherein the at least two metal portions comprise at least two magnets.

Example 18: A system for charging a smartphone from a computing device, the system comprising:
the computing device comprising:

a housing;

a display secured by the housing;

a charging coil included in a back side of the housing, the back side of the housing being on an opposite side from the display; and

at least two magnets adjacent to the charging coil;
the smartphone enclosed by a smartphone sleeve, the smartphone comprising a receiving coil and a rechargeable battery coupled to the receiving coil; and
the smartphone sleeve, the smartphone sleeve comprising:

an insulator material in a biased position, the biased position enclosing the smartphone; and

at least two metal portions surrounded by the insulator material, the at least two metal portions being at least two millimeters away from each other and less than ten centimeters away from each other,

wherein the at least two metal portions are aligned with the at least two magnets, an attractive force between the at least two metal portions and the at least two magnets being greater than a force of gravity on the smartphone.

Example 19: The system of example 18, wherein the computing device further comprises a base hingedly coupled to the housing, the base comprising a processor configured to send image instructions to the display.

Example 20: The system of either of examples 18 or 19, wherein:
the computing device is generating a magnetic field via the charging coil;
the receiving coil included in the smartphone is inducing a current from the magnetic field; and
the current is recharging the rechargeable battery.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computing device comprising:
a housing;
a display secured by the housing;
a charging coil included in a back side of the housing, the back side of the housing being on an opposite side from the display; and
at least one magnet adjacent to the charging coil.

2. The computing device of claim 1, wherein the back side of the housing includes:
a metal frame; and
an insulator portion on an opposite side of the metal frame from the display,
wherein the charging coil is disposed within the insulator portion.

3. The computing device of claim 2, wherein:
the metal frame defines a hole; and
the charging coil extends through the hole.

4. The computing device of claim 1, wherein the at least one magnet is disposed at least one millimeter away from the charging coil and less than five centimeters away from the charging coil.

5. The computing device of claim 1, wherein the at least one magnet comprises at least two magnets on opposite sides of the coil.

6. The computing device of claim 1, further comprising at least two light sources on opposite sides of the charging coil.

7. The computing device of claim 1, wherein the computing device is configured to generate a magnetic field via the charging coil in response to determining that a portable computing device is proximate to the charging coil.

8. The computing device of claim 1, wherein the computing device is configured to periodically send a ping signal via the charging coil.

9. The computing device of claim 8, wherein the ping signal has a frequency of less than one megahertz (1 MHz).

10. The computing device of claim 8, wherein the computing device further comprises a charge controller, the charge controller being configured to determine that a portable computing device is proximate to the charging coil based on receiving a device present signal in response to the probe signal.

11. The computing device of claim 10, wherein the charge controller is supported by the housing.

12. The computing device of claim 10, wherein the computing device is configured to generate a magnetic field via the charging coil in response to the charge controller determining that the portable computing device is proximate to the charging coil.

13. The computing device of claim 1, further comprising a base hingedly coupled to the housing, the base comprising a processor configured to send image instructions to the display.

14. A smartphone sleeve comprising:
an insulator material biased to enclose a smartphone; and
at least two metal portions surrounded by the insulator material, the at least two metal portions being between two millimeters and ten centimeters away from each other.

15. The smartphone of claim 14, wherein the insulator material comprises rubber.

16. The smartphone of claim 14, wherein the insulator material comprises plastic.

17. The smartphone of claim 14, wherein the at least two metal portions comprise at least two magnets.

18. A system for charging a smartphone from a computing device, the system comprising:
the computing device comprising:
a housing;
a display secured by the housing;
a charging coil included in a back side of the housing, the back side of the housing being on an opposite side from the display; and
at least two magnets adjacent to the charging coil;
the smartphone enclosed by a smartphone sleeve, the smartphone comprising a receiving coil and a rechargeable battery coupled to the receiving coil; and
the smartphone sleeve, the smartphone sleeve comprising:
an insulator material in a biased position, the biased position enclosing the smartphone; and
at least two metal portions surrounded by the insulator material, the at least two metal portions being at least two millimeters away from each other and less than ten centimeters away from each other,
wherein the at least two metal portions are aligned with the at least two magnets, an attractive force between the at least two metal portions and the at least two magnets being greater than a force of gravity on the smartphone.

19. The system of claim 18, wherein the computing device further comprises a base hingedly coupled to the housing, the base comprising a processor configured to send image instructions to the display.

20. The system of claim 18, wherein:
the computing device is generating a magnetic field via the charging coil;
the receiving coil included in the smartphone is inducing a current from the magnetic field; and
the current is recharging the rechargeable battery.
